(19) United States
(12) Patent Application Publication
(10) Pub. No.: US 2003/0222124 A1
(43) Pub. Date: Dec. 4, 2003

(54) Radio wave soldering method for semiconductor device

(76) Inventors: Yu-Peng Chung, Chai I City (TW); Robert Lee, Yung Ho City (TW); Max Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/156,149

(22) Filed: May 29, 2002

(51) Int. Cl. B23K 31/02

(52) U.S. Cl. 228/180.21; 228/248.1; 228/254

(57) ABSTRACT

A radio wave soldering method provides instant heating for substrate of semiconductor device. The radio wave soldering method can heat a local portion of a substrate rapidly to 500-600° C. The method is suitable for substrate of semiconductor device with limit heat-resistance.

### FIELD OF THE INVENTION

The present invention relates to a high frequency radio wave induced soldering method for semiconductor device, especially to a substrate of semiconductor device with limited heat resistance, which cannot proceed soldering under conventional soldering furnace condition because of their temperature limiting.

### BACKGROUND OF THE INVENTION

The semiconductor devices generally require soldering process to perform electric contact and connection for signal and power transmission. The substrates of the semiconductor devices are demanded to have good heat-resistance and good thermal conductivity. By the mean time, the material cost will raise up to fit the soldering condition requirement. A problem and the solution thereof cost reduction of semiconductor devices by choosing low cost substrate in mass production are great important for competition.

For example, FIG. 1 shows a prior art manufacturing method for semiconductor diode. The substrates 1 and 2 shown in this figure are Mutsubishi CCL-HL820 printed circuit board. The substrates 1 and 2 are electrically connected to a die 3 through a solder paste 4, which melting point is 268° C. Therefore, the soldering furnace requires at least 300° C. to melt the solder paste 4. However, according to technical manual of Mutsubishi, the heat resistance of CCL-HL820 substrate is 260° C. for 30 minutes and the soldering resistance is 350° C. for 30 minutes. Therefore, the Mutsubishi CCL-HL820 substrate has the risk of damage for conventional soldering process and soldiering equipment. This is why to develop a rapid high frequency radio wave soldering method to prevent substrate damage from soldering process.

### SUMMARY OF THE INVENTION

It is the object of the present invention to provide a high frequency radio wave soldering method providing instant heating for substrate of semiconductor device with limited heat-resistance.

In one aspect of the present invention is to provide a semiconductor devices soldering method induced by high radio wave frequency. Present invention exploit an induction coil operated at high radio wave frequency to induce an eddy current on the conductive circuit on the substrate. The induction coil only induces heat on the conductive circuit and the substrate is not directly heated. Therefore, the risk of substrate damage can be prevented by partial heating on conductive circuit of substrate.

The second aspect of present invention is to prevent the substrate damage during soldering process by applied high frequency radio wave soldering method.

The various objects and advantages of the present invention will be more readily understood from the following detailed description when read in conjunction with the appended drawing, in which:

### BRIEF DESCRIPTION OF DRAWINGS

FIG. 1 is a schematic view demonstrating a prior art soldering method for semiconductor device;

FIGS. 2A and 2B show the assembling of substrates, dies and solder paste in the present invention;

FIG. 3 shows the assembled substrates;

FIGS. 4A-4C show the perspective views of a preferred embodiment of the present invention;

FIGS. 5A-5E show the sectional views of a preferred embodiment of the present invention;

FIGS. 6A-6C show the perspective views of another preferred embodiment of the present invention.

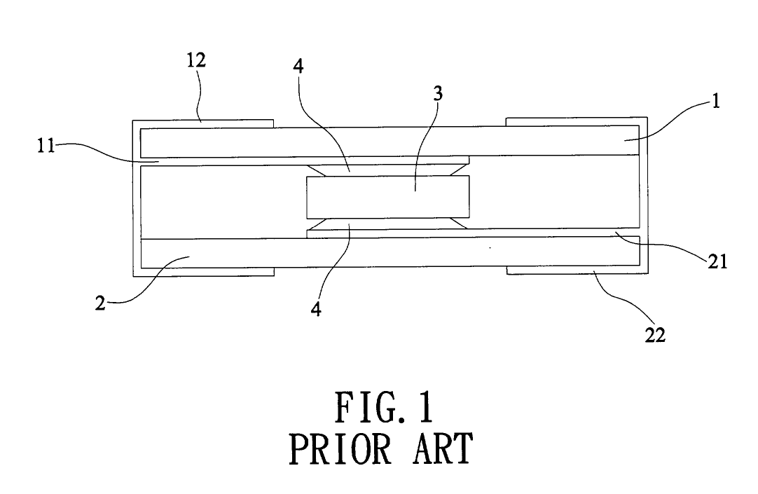

### DETAILED DESCRIPTION OF THE INVENTION

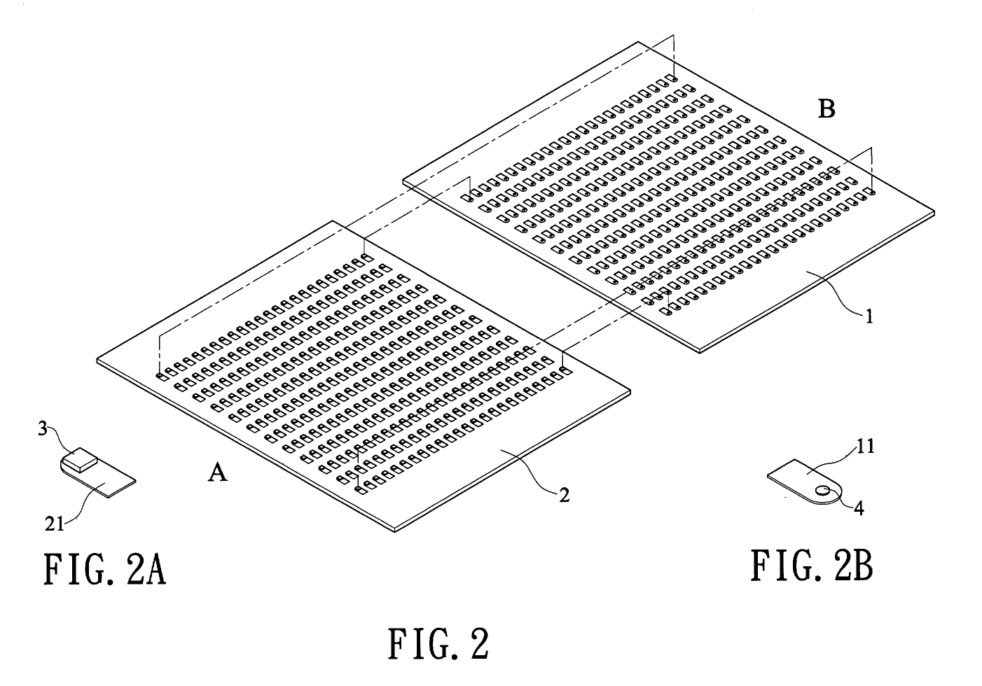

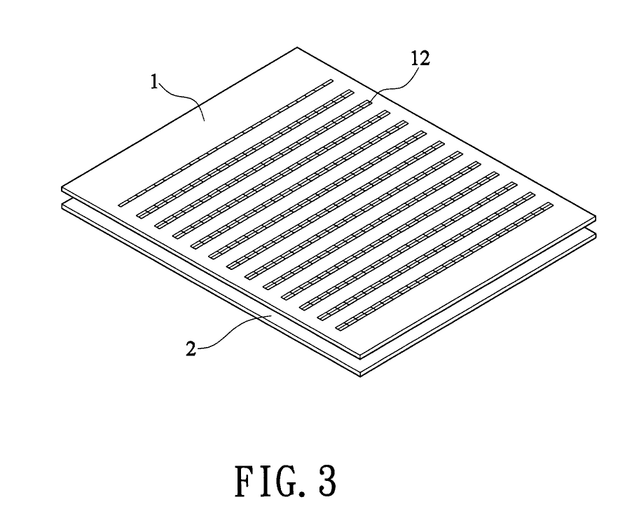

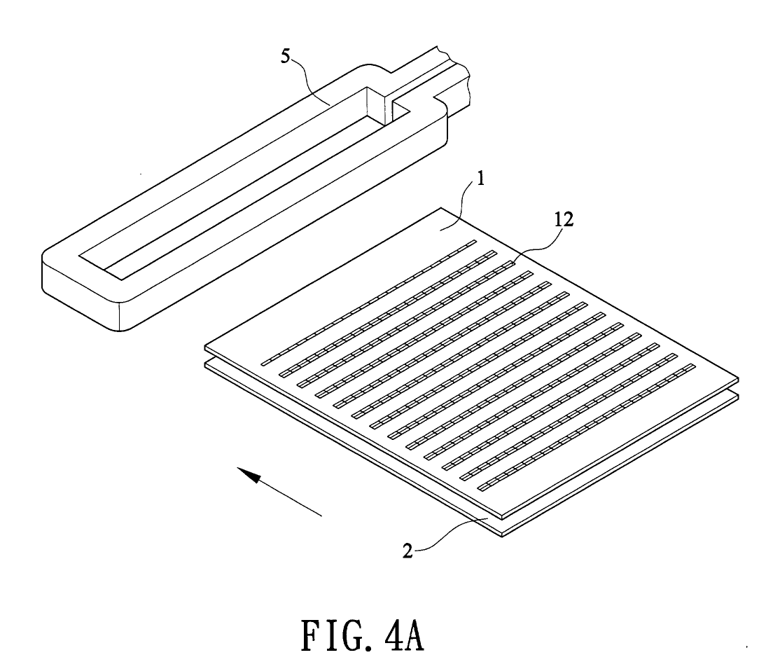

With reference now to FIGS. 2A, 2B and 3, the semiconductor device has an upper substrate 1 and a lower substrate 2, which has inner circuit 11 and 21 on the surface thereof. The upper substrate 1 and the lower substrate 2 are printed with solder paste 4 on the inner circuit 11 and 21 thereof by mesh screen-printing. Afterward, a plurality of dies 3 are placed the inner circuit 21 of the lower substrate 2, which is printed with solder paste 4. The upper substrate 1 is then placed atop the lower substrate 2 with the inner circuit 11 thereof aligned with corresponding dies 3. In other word, the upper substrate 1 faces the lower substrate 2. Afterward, the dies 3 are soldered to the inner circuit 11 and 21 of the upper substrate 1 and the lower substrate 2 by the inventive method.

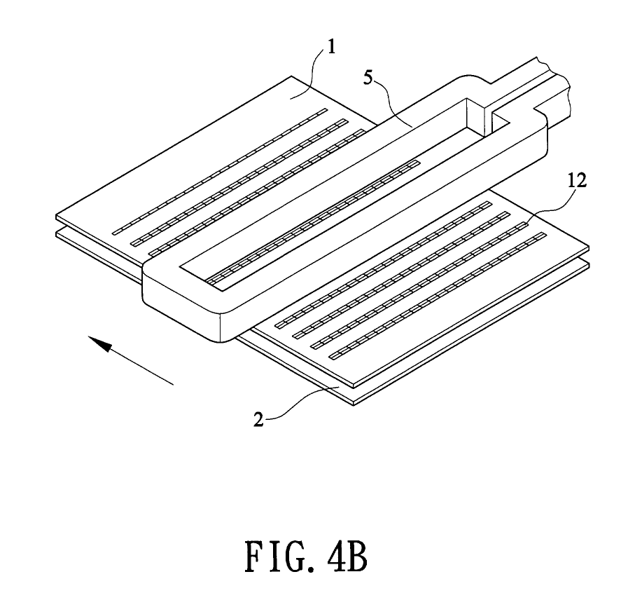

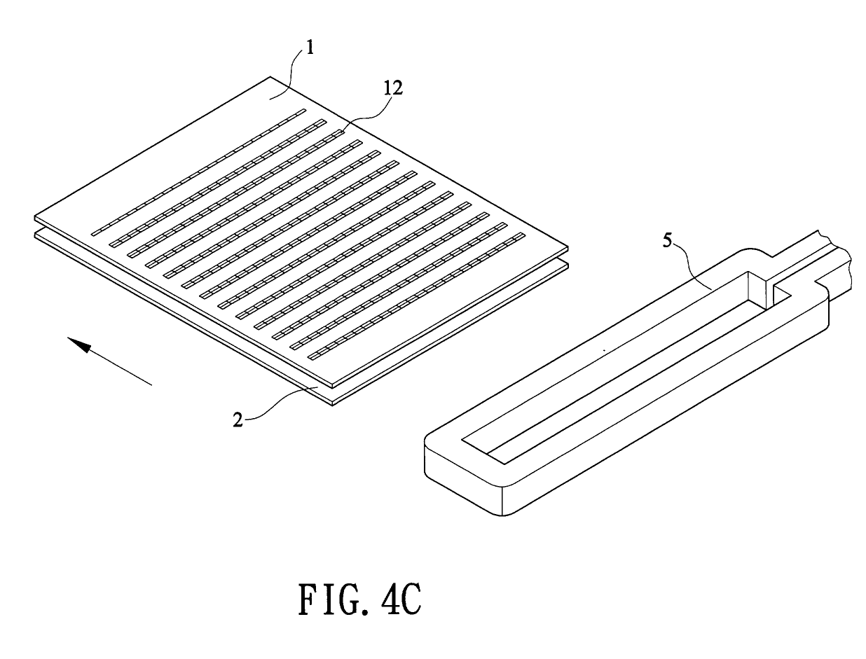

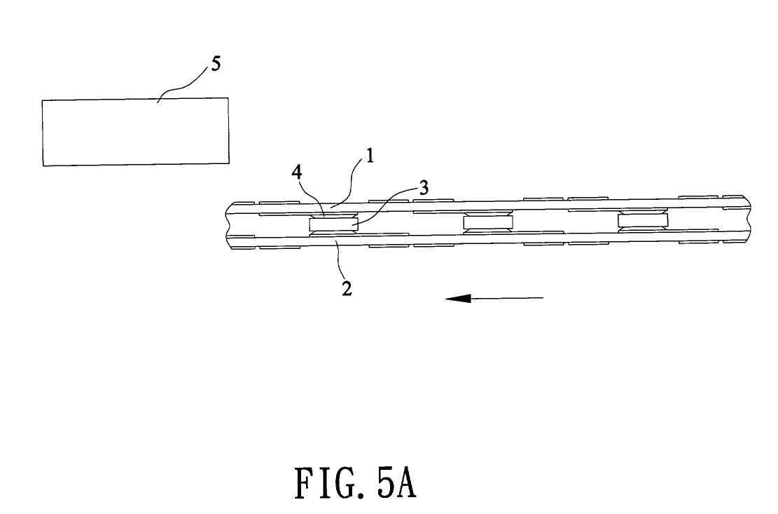

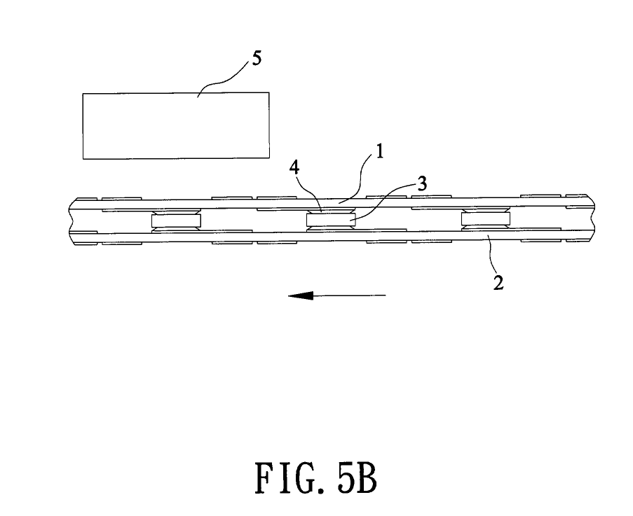

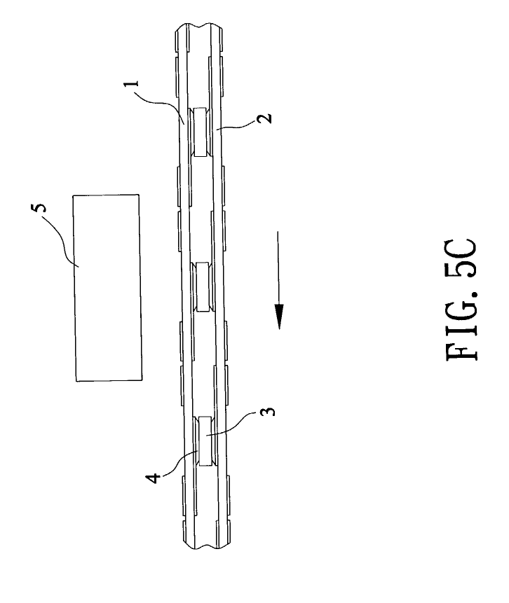

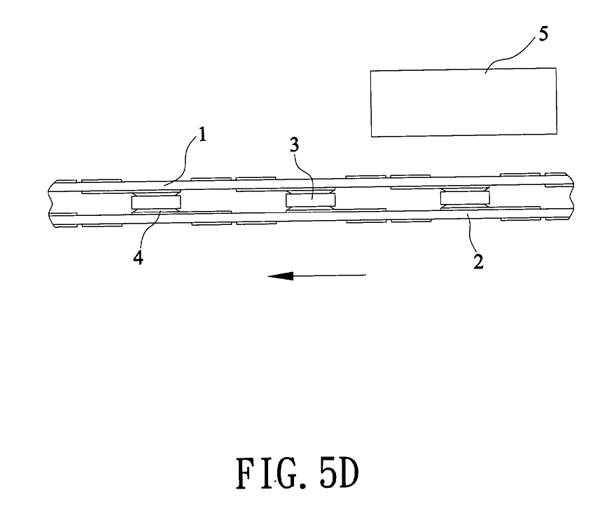

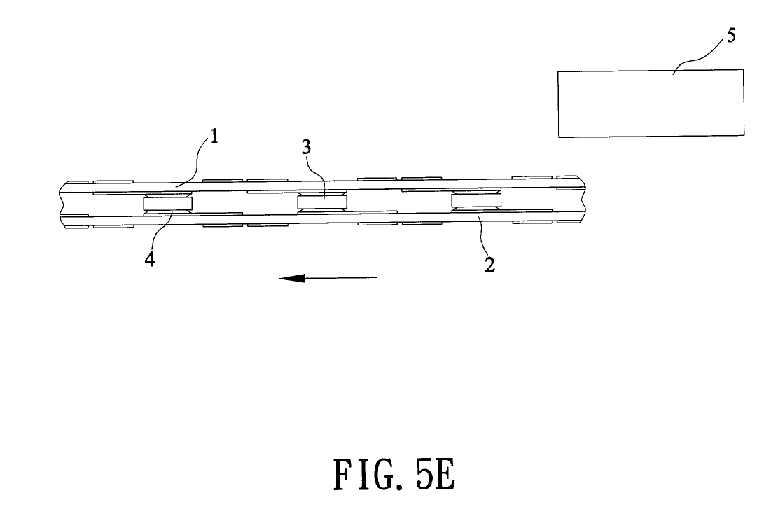

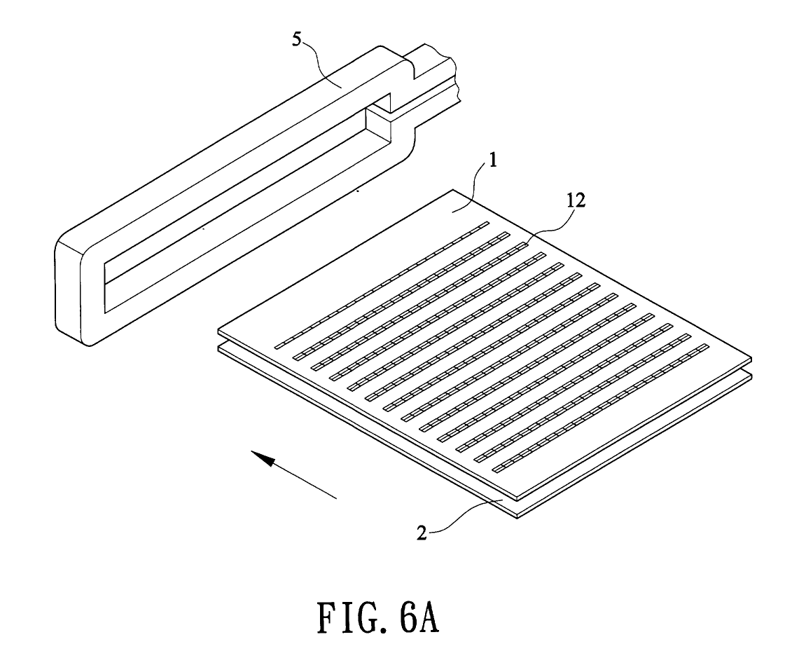

As shown in FIGS. 4 and 5, the upper substrate 1 and the lower substrate 2 are moved, by conveying means such as conveying belt (not shown), with a predetermined speed across a high frequency radio wave induction coil 5. The high frequency radio wave induction coil 5 is applied a predetermined current to generate a magnetic field. When a first row of circuit on the substrates 1 and 2 passes through the high frequency radio wave induction coil 5, an eddy current is induced on the first row of circuit and the outer circuit 12 to opposite the magnetic field. The eddy current is enhanced as the frequency of the radio wave is increased. At this time, the eddy current flowing in the first row of circuit generated a joule heat according to Ohm's law. The temperature of the first row of circuit is rapidly increased and the upper substrate 1 and the lower substrate 2 are soldered to the die 3 as the temperature of the first row of circuit reaches the melting temperature of the solder paste 4. The upper substrate 1 and the lower substrate 2 are moved with a predetermined speed across a high frequency radio wave-induction coil 5. Therefore, the first row of circuit will be moved away from the coil 5 and the induced eddy current is reduced gradually. The temperature of the first row of circuit is reduced to prevent damage of the substrates. Moreover, a cooling means, such as air-cooling means or water-cooling means, is provided at an exit of the coil 5 to accelerate the cooling speed of the first row of circuit. When a second row of circuit on the substrates 1 and 2 passes through the high frequency radio wave induction coil, 5, an eddy current is induced on the second row of circuit to opposite the magnetic field. Therefore, the temperature of the second row of circuit is also increased. By similar process, all circuits on the substrates 1 and 2 soldered to the dies 3.

In the present invention, the substrate material can be printed circuit board, leadframe, ceramic board, or any other carrier that can support the dies 3. The solder paste 4 can be solder balls, solder plates or other materials provided electrical connection after being heated.

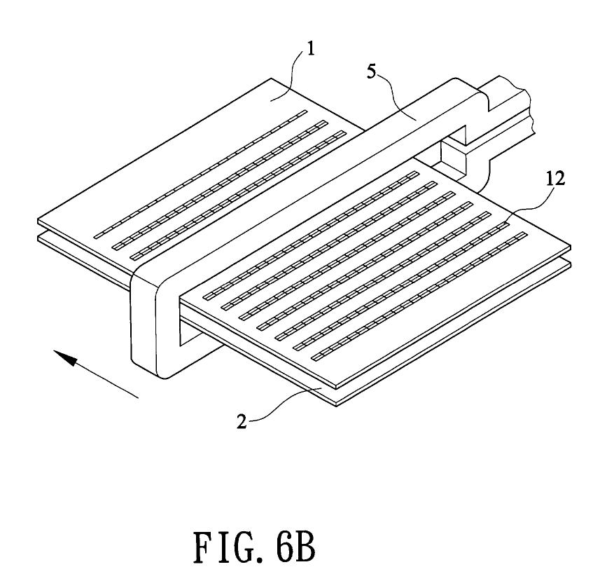

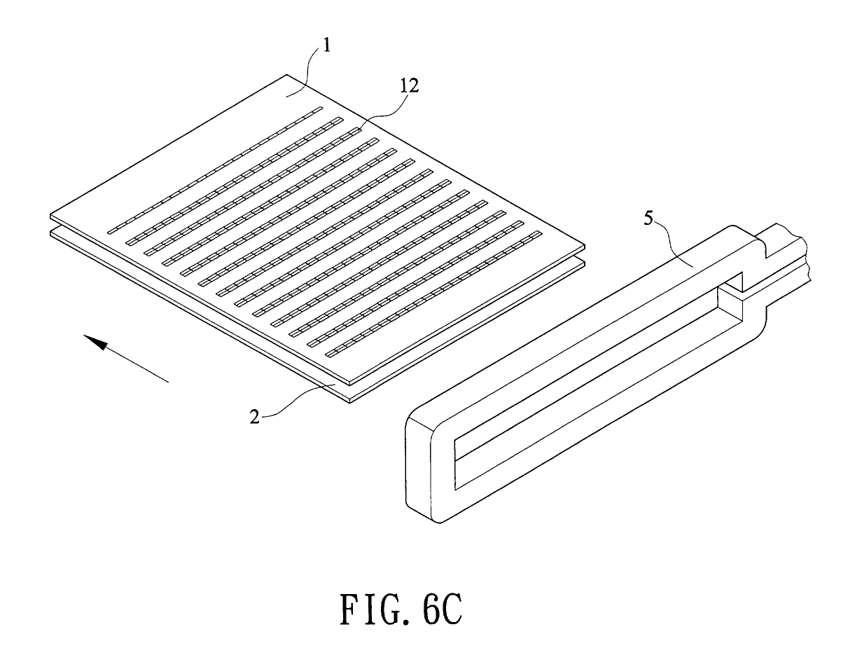

The high frequency induction coil 5 has arbitrary shape and turns number. Moreover, the substrates can pass across the high frequency induction coil 5 from topside or bottom side of the induction coil 5. Alternatively, as shown in FIGS. 6A-6C, the substrates can also pass across the center of the high frequency induction coil 5.

Although the present invention has been described with reference to the preferred embodiment thereof, it will be understood that the invention is not limited to the details thereof. Various substitutions and modifications have suggested in the foregoing description, and other will occur to those of ordinary skill in the art. For example, the inventive method can be applied to the package of LED, IC and diode, and so on). Therefore, all such substitutions and modifications are intended to be embraced within the scope of the invention as defined in the appended claims.

I claim:

1. A radio wave soldering method for semiconductor device, comprising following steps:
preparing at least one substrate patterned with a circuit, the circuit being applied with a solder thereon and a plurality of dies to be soldered being attached on the circuit applied with the solder;
moving the substrate with the circuit and the dies toward an induction coil operated at radio wave frequency, an eddy current being generated to increase temperature of the circuit, whereby the solder is melted and the dies are soldered to the circuit.

2. The radio wave soldering method for semiconductor device as in claim 1, wherein the solder can be tin paste, tin ball, tin plate or any other material providing electrical connection between the die and the circuit upon heating.

3. The radio wave soldering method for semiconductor device as in claim 1, wherein the substrate can be printed circuit board, leadframe, ceramic board, or any other carrier that can support the dies.

4. The radio wave soldering method for semiconductor device as in claim 1, wherein the coil has arbitrary shape.

5. The radio wave soldering method for semiconductor device as in claim 1, wherein the coil has arbitrary turn number.

6. The radio wave soldering method for semiconductor device as in claim 1, wherein the method is used for package of diode.

7. The radio wave soldering method for semiconductor device as in claim 1, wherein the method is used for IC package.

8. The radio wave soldering method for semiconductor device as in claim 1, wherein the method is used for package of LED.

9. The radio wave soldering method for semiconductor device as in claim 1, wherein the substrate is moved across the coil from topside of the coil.

10. The radio wave soldering method for semiconductor device as in claim 1, wherein the substrate is moved across the coil from bottom side of the coil.

11. The radio wave soldering method for semiconductor device as in claim 1, wherein the substrate is moved through the center of the coil.
